(19) United States
(12) Patent Application Publication
(10) Pub. No.: US 2020/0335005 A1
(43) Pub. Date: Oct. 22, 2020

(54) TRAINING VEST FOR DANCING

(71) Applicants: Jonathan Fulmer Green, Akron, OH (US); Rachel Marie Green, Akron, OH (US)

(72) Inventors: Jonathan Fulmer Green, Akron, OH (US); Rachel Marie Green, Akron, OH (US)

(21) Appl. No.: 16/848,116

(22) Filed: Apr. 14, 2020

Related U.S. Application Data
(60) Provisional application No. 62/835,026, filed on Apr. 17, 2019.

(51) Int. Cl. G09B 19/00; A41D 1/04

(52) U.S. Cl. CPC G09B 19/0015; A41D 1/04

(57) ABSTRACT

The present disclosure provides a dance training vest and method for dance training. The dance training vest includes a first band cuff operably engaged with the vest, a second band cuff operably engaged with the vest, and a plurality of force simulating members operably engaged with the vest, the first band cuff, and the second band cuff. The plurality of force simulating members is positioned in a desired location to assist with the simulation of proper user position during a dance movement. The method for dance training includes donning, by a user, a first dance training vest, connecting a first end of a first force simulating member to the first training vest, moving in a dance movement to move the first dance training vest, and imparting a force of the first force simulating member to the first training vest.

### CROSS-REFERENCE TO RELATED APPLICATION

This application claims priority from U.S. Provisional Patent Application Ser. No. 62/835,026, filed Apr. 17, 2019, the disclosure of which is incorporated herein by reference.

### TECHNICAL FIELD

The present disclosure relates generally to dance training aids. More particularly, the present disclosure relates to a vest having a plurality of force simulating or resistance members or components positioned in a desired location to assist with the simulation of proper user position during a dance step or a dancing maneuver. Specifically, the present disclosure provides a training vest for dancing having a plurality of resistance bands that encourage proper hand placement and body position of the user during dance training so that when the user competes in a dance competition or otherwise performs a dance routine (after removing the vest) the user will have an increased likelihood of proper body, shoulder, arm and hand positioning.

### BACKGROUND

Dance is a performing art form having purposefully selected sequences of human movement. This movement has aesthetic and, often, symbolic value. Dance is ordinarily acknowledged by performers and observers within a particular culture. Dance can be categorized and described by its choreography, by its physics, by its repertoire of movements, or by its historical period or place of origin.

Some styles or types of dance require two people, which are referred to as partners. One exemplary type of dance that has two partners is ballroom dancing. Ballroom dance is enjoyed both socially and competitively around the world. Because of its performance and entertainment aspects, ballroom dance is also widely enjoyed on stage, film, and television. Ballroom dance may refer, at its widest definition, to almost any type of partner dancing as recreation. However, with the emergence of dance sport in modern times, the term has become narrower in scope and traditionally refers to the five International Standard and five International Latin style dances as well as the four American Smooth and five America Rhythm style dances.

### SUMMARY

Dancing requires coordination of the dancer to perform a number of movements at a single time. Dancers often spend significant time practicing their dancing techniques and step routine. Issues continue to exist when dancers are practicing the step sequence for a particular dance as they can sometimes be lackadaisical in maintaining the proper position of portions their body. Thus, a need continues to exist for a dance training aid to assist dancers in maintaining a proper body position. The present disclosure address these and other issues by providing a dance training and teaching aid in the form of a vest having a plurality of resistance bands that encourage proper hand placement and body position of the user during dance training so that when the user competes in a dance competition or performs a dance routine the user will have an increased likelihood of proper body, arm, hand, legs, and feet positioning.

In one aspect, the present disclosure may provide a vest having a first elastic band and a second elastic band defining an X-shaped configuration over the rear panel of the vest. The first and second elastic bands have respective first ends connected with complementary male/female connector at configured to connect or snap together in the lower frontal portion of the vest. The first and second bands have respective second ends with hooks that may hook onto a band cuff that is worn around the palm of a user's hands or wrists. Alternatively, the hooks may be hooked onto connectors on a rear panel of a similar vest worn by a dance partner. The elastic bands simulate forces to encourage proper hand placement and body position of the user during dance training.

In another aspect, the present disclosure may provide a dance training vest comprising a first band cuff operably engaged with the vest, a second band cuff operably engaged with the vest, and a plurality of force simulating members operably engaged with the vest, the first band cuff, and the second band cuff. The plurality of force simulating members is positioned in a desired location to assist with the simulation of proper user position during a dance movement. The dance training vest further includes a first releasable connector provided on the vest releasably connected to the first band cuff and a second releasable connector provided on the vest releasably connected to the second band cuff. The dance training vest further includes a front of the vest and the first releasable connector and the second releasable connector are provided on the front of the vest.

The dance training vest further includes first and second forward quarter panels of the vest, and a rear panel of the vest connected to the first forward quarter panel at a first side and the second forward quarter panel at a second side. The first releasable connector is provided on the first forward quarter panel, and the second releasable connector is provided on the second forward quarter panel. The dance training vest further includes a plurality of connectors provided on the vest and the plurality of connectors is operably engaged with the plurality of force simulating members. In one example, the plurality of connectors includes four connectors positioned on the rear panel of the vest. Two connectors of the four connectors are positioned along a first axis and the other two connectors of the four connectors are positioned along a second axis. The first axis intersects the second axis.

The dance training vest further includes a first elastic band and a second elastic band of the plurality of force simulating members. The first elastic band includes a first end, a second end, and an elongated elastic body extending therebetween. The second elastic band includes a first end, a second end, and an elongated elastic body extending therebetween. The dance training vest further includes a connection between respective first ends of the first and second elastic bands forwardly from the first and second quarter panels and below the first and second releasable connectors. The first elastic band extends generally along the first axis through apertures defined by two of the four connectors and the first elastic band is releasably connected to the first band cuff. The second elastic band extends generally along the second axis through apertures defined by the other two of the four connectors and the second elastic band is releasably connected to the second band cuff.

The dance training vest further includes a left upper connector provided on the rear panel of the vest and a right upper connector provided on the rear panel of the vest. The left upper connector and the right upper connector are configured to releasably receive the first elastic band and the second elastic band.

In another configuration, the dance training vest further includes a plurality of lower connectors provided adjacent a bottom of the vest, a first elastic band of the plurality of force simulating members, and a second elastic band of the plurality of force simulating members. The first elastic band includes a first end, a second end, and an elongated elastic body extending therebetween. The second elastic band includes a first end, a second end, and an elongated elastic body extending therebetween. In this configuration, the dance training vest further includes a releasable connection between respective first ends of the first and second elastic bands with the plurality of lower connectors. The first elastic band is releasably connected to the first band cuff and the second elastic band is releasably connected to the second band cuff.

In another aspect, the present disclosure may provide a method for dance training comprising donning, by a user, a first dance training vest, connecting a first end of a first force simulating member to the first training vest, moving in a dance movement to move the first dance training vest, and imparting a force of the first force simulating member to the first training vest. The method further includes operably engaging a second end of the first force simulating member to a first band cuff, moving a first arm of the user toward the first band cuff, grasping, with a first hand of the user, the first band cuff, placing the first arm, the first hand, and the first band cuff of the user in a first proper dance alignment, moving in the dance movement to move the first dance training vest, and imparting the force of the first force simulating member to the dance training vest to maintain the first arm, the first hand, and the first band cuff in the first proper dance alignment while moving in the dance movement. The method further includes removing the first dance training vest, repeating the dance movement without the first training vest, and maintaining the first proper dance alignment during the dance movement in a manner trained through the impartment of the force via the first force simulating member while the first training vest was worn.

The method further includes connecting a first end of a second force simulating member to the first training vest, operably engaging a second end of the second force simulating member to a second band cuff, moving a second arm of the user toward the second band cuff, grasping, with a second hand of the user, the second band cuff, placing the second arm, the first hand, and the first band cuff of the user in a second proper dance alignment, moving in the dance movement to move the first dance training vest, and imparting a force of the second force simulating member to the dance training vest to maintain the second arm, the second hand, and the second band cuff in the second proper dance alignment while moving in the dance movement. The method further includes removing the first dance training vest, repeating the dance movement without the first training vest, and maintaining the second proper dance alignment during the dance movement in a manner trained through the impartment of the force via the second force simulating member while the first training vest was worn.

The method further includes connecting a second end of the first force simulating member to a second dance training vest adapted to be donned by a dance partner, moving in the dance movement in a proper dance alignment to move the first dance training vest simultaneous to movement of the second dance training vest, and imparting the force of the first force simulating member simultaneously to both the first training vest and the second training vest. The method further includes removing the first dance training vest, repeating the dance movement without the first training vest, and maintaining the proper dance alignment during the dance movement in a manner trained through the impartment of the force via the first force simulating member while the first training vest was worn.

The method further includes connecting a first end of a second force simulating member to the first training vest, operably engaging a second end of the second force simulating member to the second dance training vest, moving in the dance movement in the proper dance alignment to move the first dance training vest simultaneous to movement of the second dance training vest, and imparting the force of the first force simulating member and the second force simulating member simultaneously to both the first training vest and the second training vest. The method further includes removing the first dance training vest, repeating the dance movement without the first training vest, and maintaining the proper dance alignment during the dance movement in a manner trained through the impartment of the force via the first force simulating member and the second force simulating member while the first training vest was worn.

In another aspect, the present disclosure may provide a dance training vest and method for dance training. The dance training vest includes a first band cuff operably engaged with the vest, a second band cuff operably engaged with the vest, and a plurality of force simulating members operably engaged with the vest, the first band cuff, and the second band cuff. The plurality of force simulating members is positioned in a desired location to assist with the simulation of proper user position during a dance movement. The method for dance training includes donning, by a user, a first dance training vest, connecting a first end of a first force simulating member to the first training vest, moving in a dance movement to move the first dance training vest, and imparting a force of the first force simulating member to the first training vest.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front elevation view of a dance training vest in accordance with one aspect of the present disclosure.

FIG. 2 is a rear elevation view of the dance training vest.

FIG. 3 is a diagrammatic view of the vest being worn by a user with the user's hands operably engaged with band cuffs.

FIG. 4 is a diagrammatic view of the vest being worn by a user and the proper position for arms of the user while practicing a dance step sequence.

FIG. 5 is diagrammatic view of a first dancer wearing a first vest and a second dancer wearing a second vest and the vests being connected together while simulating a force that trains the first and second dancers to maintain a proper dancing position with a partner.

FIG. 6 is a diagrammatic view of one dancer wearing the vest and connecting a force simulating or resistance member or component to a wall to simulate a force that trains the dancer to maintain a proper dancing position.

FIG. 7 is a front elevation view of the dance training vest of the present disclosure having a plurality of connectors adjacent a lower hem or edge sized to couple force simulating member to a supplemental cuff worn on the body below the vest.

FIG. 8 is a rear elevation view of the dance training vest of the present disclosure having a plurality of connectors adjacent a lower hem or edge sized to couple force simulating member to a supplemental cuff worn on the body below the vest.

FIG. 9 is a front elevation view of the lower portion of dancer wearing the dance training vest depicting force simulating members connected in one configuration to a supplemental cuff worn around an ankle region of the dancer below the vest.

FIG. 10 is a flowchart depicting one method in accordance with one aspect of the present disclosure.

Similar numbers refer to similar parts throughout the drawings.

### DETAILED DESCRIPTION

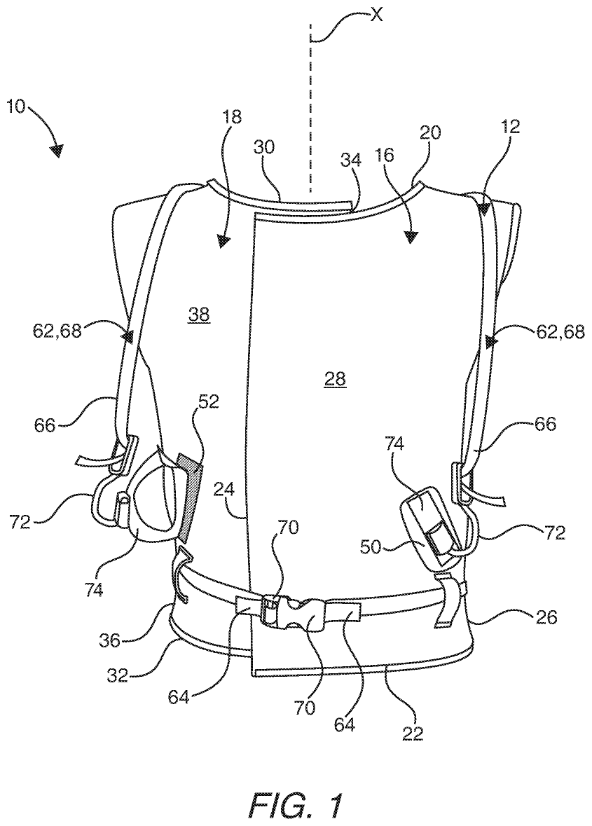

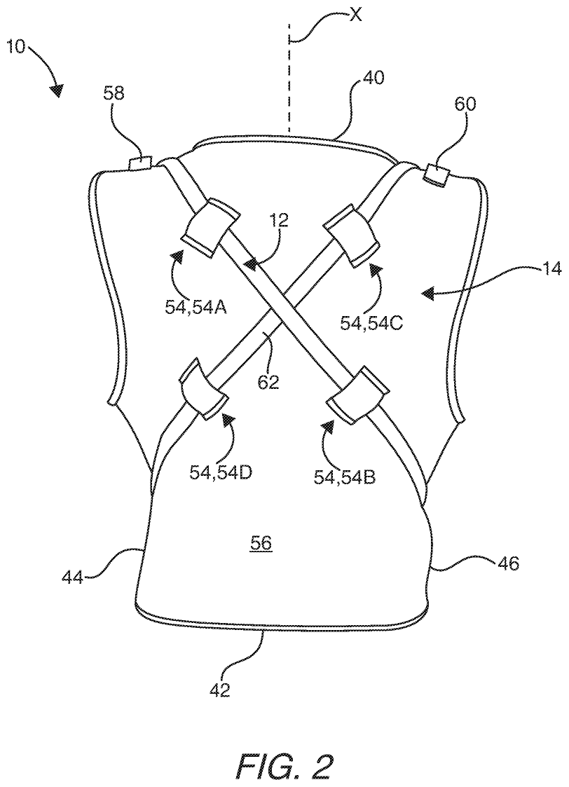

FIG. 1 and FIG. 2 depict a dance training vest in accordance with the present disclosure generally at 10. As will be discussed in greater detail below, vest 10 includes a plurality of force simulating or resistance members or components 12 that are carried by some or all of the vest 10 panels. The force simulating or resistance members 12 enable a user to interact with the same to represent or simulate the forces a user experiences while dancing with a partner. The resistance members 12 may also impart a resistive force to user to train the user of a proper body position while performing a dance routine. Thus, vest 10 is a dance training aid or tool that allows a user (i.e., a wearer of the vest) to train for a dance without the need of a partner. However, the vest 10 is also able to be used in conjunction with a similar second vest worn by a dance partner (wherein the second vest 10 can be different size to accommodate the partner) and includes connectors that ensures the two partners are in a proper dancing position during training. Thus, vest 10 is a versatile dance training aid that can be used by one person individually or two people collectively for dance training.

Vest 10 includes a rear panel 14, a forward first quarter panel 16, and a forward second quarter panel 18. The vest 10 is constructed in a manner so as to allow a user to wear vest 10 in a typical manner by moving respective left and right arms through aperture defined by the panels, when they are assembled and allowing the quarter panels 16,18 to releasably connect in the front. The panels may be made from conventional and durable fabric material; however any wearable material shall suffice.

The forward first quarter panel 16 has an upper edge or hem 20 and a lower edge or hem 22 defining a vertical direction therebetween relative to a longitudinal axis X. First quarter panel 16 has a vertical forward edge or hem 24 and a vertical side edge or hem 26 that extends in a transverse direction relative to a frontal axis. First quarter panel 16 has front or outer surface 28 and an opposite rear or inner surface. Some portions of the outer surface 28 and inner surface near the forward hem define a sagittal direction therebetween relative to a sagittal axis.

The forward second quarter panel 18 has an upper edge or hem 30 and a lower edge or hem 32 extending in the vertical direction relative to the longitudinal axis X. Second quarter panel 18 has a vertical forward edge or hem 34 and a vertical side edge or hem 36 that extends in the transverse direction relative to the frontal axis. Second quarter panel 18 has a front or outer surface 38 and an opposite rear or inner surface. Portions of the outer surface and inner surface of the second quarter panel 18 near the forward hem extend in the sagittal direction relative to the sagittal axis.

The respective vertical forward edges or hems 24,34 of the first and second quarter panels 16,18 are sized and configured to overlap or join together when worn by the user. Thus, there may be complementary components adjacent or at the vertical forward edges 24, 34 to effectuate the vest 10 from moving from an open position and closed position. Any conventional components could be utilized, such as, zippers, buttons, or hook-and-loop closures (i.e., Velcro®). In one embodiment, the respective side edges or hems 26, 36 of the first and second quarter panels 16,18 are disposed on opposite sides of the vest 10 but may be along the same frontal plane.

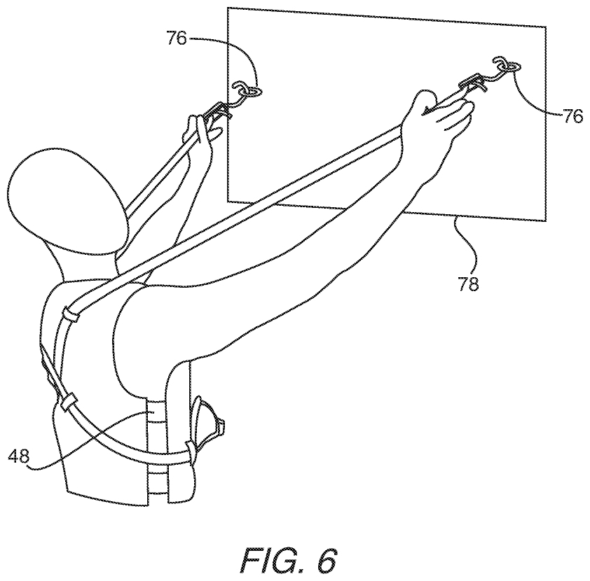

The rear panel 14 of vest 10 has an upper edge or hem 40 and a lower edge or hem 42. The rear panel 14 of the vest 10 has vertical first side edge 44 and a vertical second side edge 46. The rear panel 14 is sized to span the entire width of the rear portion of the vest 10. In one embodiment, the first side edge 44 of the rear panel 14 is directly coupled with the vertical side edge 26 of the first quarter panel 16. In another embodiment, the first side edge 44 of the rear panel 14 is indirectly coupled or connected to with the vertical side edge 26 of the first quarter panel 16 via an elastic member 48 (FIG. 6) to provide adjustability for vest 10 to flexibly expand depending on the chest or bust size of the user. Alternatively, other size adjusting mechanism could indirectly couple the first side edge 44 of the rear panel 14 with the vertical side edge 26 of the first quarter panel 16.

Each of the panels 14,16,18 include a variety of connectors that are configured to retain the plurality of force simulating or resistance members 12 or components in a desired location to assist with the simulation of a dance step or a dancing maneuver.

The first quarter panel 16 includes a releasable connector 50 that is coupled to and extends outwardly from the outer surface 28. In one embodiment, the releasable connector 50 on the first quarter panel 16 has a length dimension and a width dimension. The length dimension is oriented at an angle in a range from about 30 degrees to about 60 degrees relative to the longitudinal axis X. The width dimension is oriented at an angle in a range from about 30 degrees to about 60 degrees relative to the frontal axis.

Similar to the first quarter panel 16, the second quarter panel 18 includes a releasable connector 52 that is coupled to and extends outwardly from the outer surface 38. In one embodiment, the releasable connector 52 on the second quarter panel 18 has a length dimension and a width dimension. The length dimension is oriented at an angle in a range from about 30 degrees to about 60 degrees relative to the longitudinal axis X. The width dimension is oriented at an angle in a range from about 30 degrees to about 60 degrees relative to the frontal axis.

In one particular embodiment, the respective length dimensions and width dimensions of the releasable connectors 50,52 on the first and second quarter panels 16,18 are equal. In another particular embodiment, the angles at which the releasable connectors 50,52 on the first quarter panel 16 and the second quarter panel 18 are oriented relative to the longitudinal axis and the frontal axis are the same. In another embodiment, the respective releasable connectors 50,52 are formed from similar material. For example, and in one particular embodiment, the releasable connectors 50,52 are formed from one-half a hook-and-loop connector. However, any type of releasable connector should suffice.

The rear panel 14 includes a plurality of connectors 54 connected to the outer surface 56 of the rear panel 14 configured to secure the plurality of force simulating or resistance members 12 or components in a desired location to assist with the simulation of force during a dance step or a dancing maneuver. In one embodiment, the rear panel 14 includes four connectors 54, which may also be referred to as central connectors, arranged an X-shaped configuration, wherein one connector of the four is positioned at each respective end of the X-shaped. Alternatively, the four connectors 54 may be in a square-shaped configuration having one connector from the four positioned each respective corner of the square configuration. The connectors 54 may be defined by a short segment of material that is secured to the outer surface of the rear panel 14 at the ends of the short segment so that a through aperture is defined by an interior surface of the short segment connector and the outer surface 56 of the rear panel 14. The apertures enable the plurality of force simulating or resistance members 12 or components to extend therethrough.

The four connectors 54 on the rear panel 14 may include two connectors associated along a similar axis and two other connectors associated along another similar axis that intersects the axis defined by the first two connectors. Stated otherwise, the connector 54A located at the top left of the X-shaped configuration and the connector 54B located at the bottom right of the X-shaped configuration define apertures that are aligned on the same axis so that one of the force simulating or resistance members 12 or components extends along this axis diagonally across the outer surface 56 of the rear panel 14. Similarly, the connector located 54C at the top right of the X-shaped configuration and the connector 54D located at the bottom left of the X-shaped configuration defined apertures that are aligned on the same axis so that another one of the force simulating or resistance members 12 or components extends along this axis diagonally across the outer surface of the rear panels 16,18. The two force simulating or resistance members 12 or components form an X-shaped intersection exterior to the outer surface 56 of the rear panel 14 near its vertical center. In some implementations, the two members or components may be secured together, however it is not necessary and other embodiments provide that they are independent from each other in the X-shaped configuration.

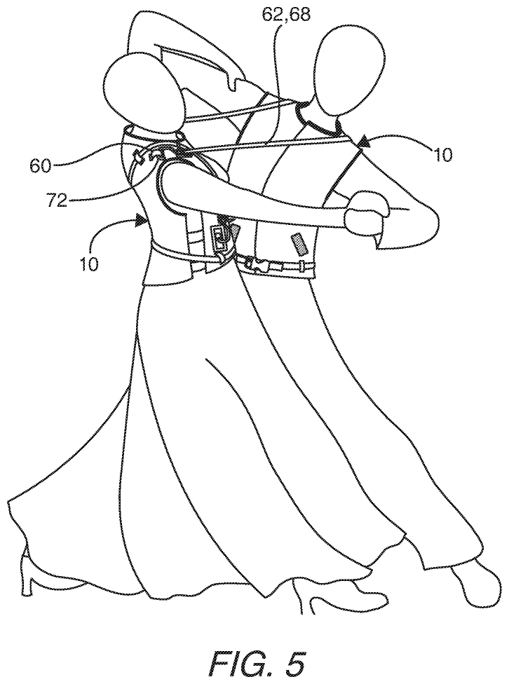

The rear panel 14 may further include left and right upper connectors 58, 60. According to a preferred embodiment, the upper connectors 58, 60 are formed from metal D-rings sewn to the vest at respective left and right panels as shown in the figures. According to another embodiment, the upper connectors 58,60 may be formed from short connectors of material that are connected to the rear panel 14 at their respective ends near the left and right shoulder portions of the rear panel 14. When the connectors 58, 60 are segments of material, the outer surface 56 of the rear panel 14 and the inner surface of the upper connectors 58,60 define an aperture. When the connectors 58, 60 are D-rings, the D-ring forms an aperture to which a hook or clip is connected. The aperture defined by the upper connector 58 is not configured to receive one of the elongated force simulating or resistance members or components therethrough. Rather, the upper connectors 58,60 are sized to receive a clip or hook (i.e., hook 72, infra) therethrough from a force simulating or resistance member or component on a second vest 10A (FIG. 5) worn by a partner, as described in greater detail below.

The left upper connectors 58 is connected to the rear panel 14 adjacent its upper edge or hem 40 in a left shoulder region. In one embodiment, the left upper connector 58 has a length dimension that is oriented generally parallel or parallel to the upper edge or hem of the rear panel 14. Similarly, the right upper connector 60 is connected to rear panel 14 adjacent its upper edge or hem 40 in a right shoulder region. In one embodiment, the right upper connector 60 has a length dimension that is oriented generally parallel or parallel to the upper edge or hem of the rear panel 14. In one embodiment, the left and right upper connectors 58, 60 are oriented along a single frontal plane.

Reference will now be made to the plurality of force simulating or resistance members 12 or components and how they are connected to the vest 10. In one particular embodiment, each of the force simulating or resistance members or components are substantially similar in construction and, as such, will be discussed collectively. For example, one of the plurality of force simulating or resistance members or components may be an elastic resistance band 62. The elastic band 62 may have a first end 64 and a second end 66 with an elongated elastic body 68 extending therebetween. The elastic body 68 may have any shape in cross section, such as circular or rectangular. However, it may be preferable to utilize a rectangular cross section such that a flat surface of the band lies flat against the outer surface of the rear panel 14 and the quarter panels 16,18.

The first end 64 of the elastic band 62 may have a releasable connector 70 such as one of a male clip or a female clip. For example, the releasable connector 70 at the first end 64 of the elastic band 62 may be either the male clip or the female clip of a one-inch black plastic clip/buckle 70 that are dual adjustable defining a single side release. A connection mechanism 72 defines the second end 66 of elastic band 62. The connection mechanism 72 may any type of releasable connector, such as a hook, D-ring, carabineer or clip, and may also be referred to collectively herein as a hook 72. The hook 72 is configured to releasably connect with a complementary connector on a band cuff 74. In some examples, the band cuff has a sewn loop to which the hook 72 connects. In one particular embodiment, the band cuff 72 carries a D-ring to which the hook 72 is sized to connect with.

The band cuff 74 is a piece of material that is generally annular in shape defining an inner surface and an outer surface. The band cuff 74 may be made from a flexible fabric sewed together to have an outer circumference in a range from about six to about ten inches, however other sizes are available. In some embodiments, the fabric utilized to fabricate the band cuff 74 could be the same material as the panels that form the vest 10.

The outer surface of the band cuff 74 carries the other half of the releasable connector that is configured to connect with the releasable connector 52 on the first and second quarter panels 16,18. For example, when the releasable connector 52 on the first quarter panel 16 is formed from a hook-and-loop connector, the loop portion may be on the first quarter panel 16 and the hook portion is on the band cuff 74. Thus, the band cuff 74 is releasably connected to the front quarter panel 16. The band cuff 74 may be a single size (i.e., non-adjustable) annular member that is configured to be grasped by a hand of the user. Alternatively, the band cuff 74 may be adjustable such that it is in the form of a strap having ends that can be adjustably connected together to form the annular configuration and may be placed around the wrist, forearm, or bicep of the user (or any other location on the user's arm distal of the shoulder). On the band cuff 74, opposite the other half of the releasable connector 52 is the portion of the band cuff 74, which may be a D-ring or a sewn loop, that connects with hook 72.

Having thus described the structure of one of the elastic bands 62, reference is now made to its connection to the vest 10. One of the elastic bands 62 is fed through one connector on rear panel 14. For example, the first end 64 having a male or female single sided clip connector can be fed through the short segment of connector 54C in the upper right corner of the X-shaped configuration. The first end 64 may then be fed through the short segment connector 54D of the lower left corner of the X-shaped configuration. This elastic band 62 may then be oriented in a diagonal orientation relative to the outer surface 56 of the rear panel 14. The axis along which the elastic band may be oriented at an angle in a range from about 30 degrees to about 60 degrees relative to the longitudinal axis X. The elastic body 68 may extend downwardly towards the lower edge or hem 42. The first end 64 extends around and over the first side edge 44 of the rear panel 14 and the side edge 26 of the first quarter panel 16 of the vest 10. The body 68 of the elastic band 62 extends across the frontal plane and disposes the first end 64 of the elastic band 62 forwardly from the outer surface 28 of the first quarter panel 16. The first end 64 of the elastic band 62 is positioned adjacent the lower edge or hem 22 of the first quarter panel 16 and is vertically below the releasable connector 50 and the band cuff 74 connected thereto. The second end 66 of the elastic band 62 having to hook 72 extends diagonally upwardly towards the right shoulder region of the rear panel 14. The hook and body of the elastic band 62 are passed over the upper right connector 60 and do not extend through its aperture. The hook and body of the elastic band 62 extend over the right shoulder region and vertically downward along the outer surface 38 of the second quarter panel 18 forwardly therefrom. The hook 72 connects with the complementary connector on the band cuff releasably connected to the second quarter panel 18 via connector 52.

With respect to the second elastic band 62, the first end 64 having a male or female single sided clip connector can be fed through the connector 54A in the upper left corner of the X-shaped configuration. The first end 64 may then be fed through the connector 54B of the lower right corner of the X-shaped configuration. This elastic band 62 may then be oriented in a diagonal orientation relative to the outer surface 56 of the rear panel 14. The axis along which the second elastic band may be oriented at an angle in a range from about 30 degrees to about 60 degrees relative to the longitudinal axis. In one embodiment, the angle is an negative equivalent of the angle associated with the first elastic band 62 relative to the longitudinal axis (i.e., if the first axis is 45 degrees relative to the longitudinal axis, then the second angle is −45 degrees relative to the longitudinal axis). The body 68 of the second elastic band 62 may extend downwardly towards the lower edge or hem 42. The first end 64 then extends around and over the second side edge 46 of the rear panel 14 and the side edge 36 of the second quarter panel 18 of the vest 10. The body 68 of the elastic band 62 extends across the frontal plane and disposes the first end 64 of the second elastic band 62 forwardly from the outer surface 38 of the second quarter panel 18. The first end 64 of the second elastic band 62 is positioned adjacent the lower edge or hem 32 of the second quarter panel 18 and is vertically below the releasable connector 52 and the band cuff 74 connected thereto. The second end 66 of the elastic band 62 having the hook 72 extends diagonally upwardly towards the left shoulder region of the rear panel 14. The hook 72 and body of the elastic band 62 are passed over the upper left connector 58 and do not extend through its aperture. The hook and body of the elastic band 62 extend over the left shoulder region and vertically downward along the outer surface 28 of the first quarter panel 16 forwardly therefrom. The hook 72 connects with the complementary connector on the band cuff 74 releasably connected to the first quarter panel 16 via connector 50.

The male or female connector on the first end 64 of the first elastic band 62 connects to the complementary male/female connector on the first end 64 of the second elastic band 62. In one exemplary embodiment, these connectors define a single sided connection that can be released with a single hand by depressing clasp arms on the male connector to release it from the female connector. When connected, the two connectors are disposed forwardly from the front edges 24,34 of the first and second quarter panels 16,18 above their respective bottom hems or edges 22,32. In one embodiment, the female connector is on the first elastic band 62 positioned forwardly from the first quarter panel 16 and the male connector is on the second elastic band 62 positioned forwardly from the second quarter panel 18. This particular configuration may be advantageous over a reversal of parts inasmuch as this would encourage a right-handed user to be able to disconnection the male/female connection with one hand (i.e., the user's right hand).

An alternative configuration of vest 10 can be used as a dancing aid and teaching aid for use and association with Latin/Rhythm training, however other dance styles are possible. For example, this configuration of the vest could also be used for contemporary dance, ballet, jazz, tap, ballroom or other dance styles. The second configuration uses similar components of vest 10 arranged in a different manner so as to allow the wearer or user of the vest 10 to become more aware of the movement of their ribcage. When using vest 10 in a Latin/Rhythm training configuration, an armband is substituted for the cuff band and is connected proximally from the elbow joint around the wearer or user's bicep. The bands extend around the rear panel 14 through the lower connectors 54D,54B. More particularly, the first elastic band 62 extends through connector 54D and its second end 66 having hook 72 connects with an armband worn on the right arm of the user of the vest 10. The second elastic band 62 connects at its second end 66 having hook 72 with another respective armband worn by the left arm of the wearer or user around their bicep region proximally from the elbow joint. In the second configuration, neither elastic band 62 extends through the upper connectors 54A,54C. Thus, the intersection of the X-shaped configuration is vertically lowered along longitudinal axis X. In this embodiment or other embodiments, bypassing the upper connectors 54A, 54C may be optional. Vest 10 can also function with the elastic band extended through the upper connectors as in the original configuration.

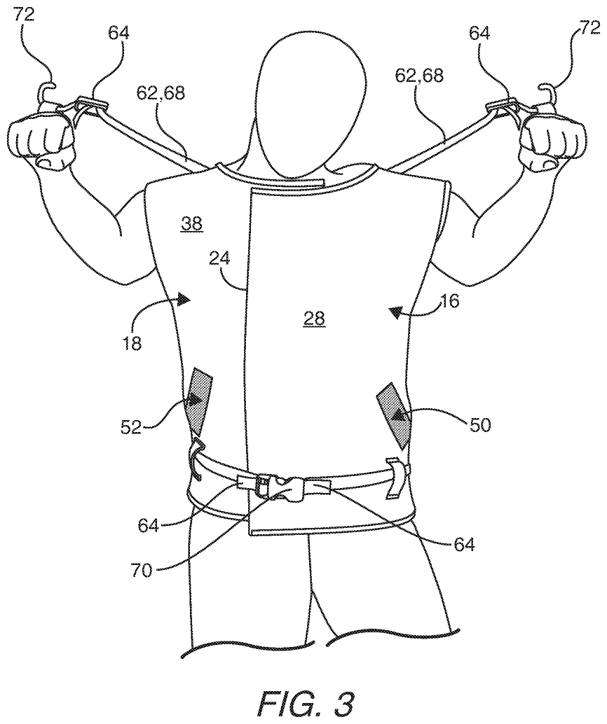

Having described the structure of the vest 10 and its associated components, reference is now made to FIG. 3 through FIG. 6 to depict one exemplary use and operation of vest 10.

Initially, the user shall don (i.e., put on) the vest 10 by opening the first and second quarter panels 16,18. Then, the user will have access to move their arms through the arm holes defined by panels. With the vest 10 draped from the shoulders, the user may close the vest by connecting the front edges of the first and second quarter panels 16,18. As discussed above, this may be accomplished in a conventional manner, such as through the use of a zipper, buttons, or a hook-and-loop connection.

FIG. 3 depicts that when training with vest 10 without a partner wearing a similar vest, the user will place its right hand into the band cuff 74 connected to the second quarter panel 18 and place its left hand into the band cuff 74 connected to the first quarter panel 16. The user will manipulate their hands to disconnect the band cuffs 74 from their respective panels. When the band cuffs 74 are disconnected from the panels, the hook 72 on the elastic band 62 remains connected to the band cuff 74. More particularly, the hook 72 at the second end 66 of the first elastic band 62 remains connected to the band cuff 74 connected to the right hand of the user. The hook 72 at the second end 66 of the second elastic band 62 remains connected to the band cuff 74 connected to the left hand of the user.

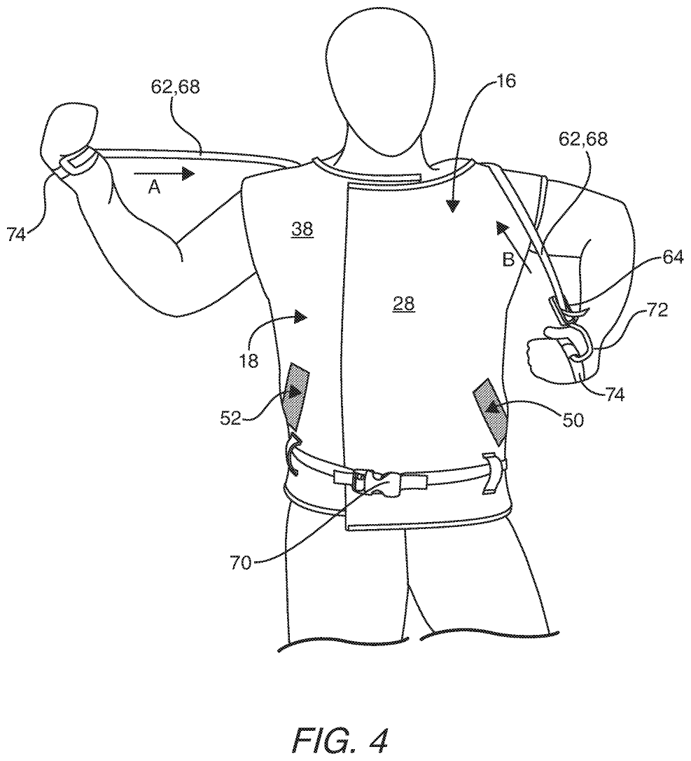

FIG. 4 depicts that the user may then place their arms into a dancing position. With respect to ballroom dancing and from the perspective of a dance follower, which is typically the female partner, her right arm is extending outwardly and upwardly. With his arm in the outward and upward position, the band cuff 74 is placed around the palm on his right hand. The body 68 of the elastic band 62 imparts resistance, as indicated by Arrow A, that simulates the need or reminder for the dance follower to maintain her hand in the upward and outward position. This is helpful inasmuch as dancers typically get lackadaisical or lazy during dance practice and let their arms slouch. The resistance imparted by the elasticity of the body 68 of the elastic bands 62 simulates the force required for the dancer to maintain the right arm in the upward and outwardly position. In one particular embodiment, the elastic band 62 is configured for the user/dancer to maintain her arm in a static upward and outward position. Stated otherwise, this vest 10 and elastic band 62 of the present disclosure is distinctly different in use and operation from an exercise vest that may have an elastic band attached configured for the wearer to dynamically perform repetitive exercise movements.

The left hand of the dance follower may be placed through the band cuff 74 connected to the hook 72 at the second end 66 of the second elastic band 62. The user/dancer may then put her left arm generally horizontally outward slightly bent at the elbow to simulate the hand position of placing her left hand on the upper arm of her partner, which is typically male. The resistance imparted by the elasticity of the body of the second elastic band 62 simulates the force required for the dancer to maintain the left arm in the horizontally outward and slightly bent position. The resistance is indicated by Arrow B. In one particular embodiment, the second elastic band 62 is configured for the user/dancer to maintain her left arm in a static horizontally outward and slightly bent position.

With his right arm in the upward and outward position and his left arm in the horizontally outward and slightly bent position. The dancer may train with the vest 10 by moving his feet in a desired sequence that should be same dance step sequence that is required when he dances with a partner. The vest 10 encourages the dancer to maintain his arms in the proper position while working on perfecting the steps with his feet. As stated previously, when dancers practice their dance step sequence, they have a tendency to let their arms fall out of position because they are concentrating on their feet. Thus, the vest 10 and elastic bands 62 operate to simulate a force on the arms to “remind” the dancer to keep their arms in a proper position.

Notably, the proper hand and arm positioning varies on the type of dance. For example, arm placement for a wearer of the vest differs from ballroom dancing, a waltz, fox trot, or tango. The resistance imparted by the elastic bands 62 are operable to simulate the proper force required to keep and maintain arms in a proper placement regardless of the style of dance that the dancer/user is practicing.

FIG. 5 depicts a dance training scenario of two partners each wearing a respective vest sized to fit their respective body. In this scenario, there is a male first partner (i.e., the dance leader) and a female second partner (i.e., the dance follower). In a ballroom dancing technique, the partners are supposed to press their hips or lower bodies together while their shoulders are generally spaced apart. During conventional training (i.e., when not wearing vest 10), dance partners typically get lackadaisical and generally stand more upright over time. The upright stance moves their lower bodies apart and brings their upper bodies together, which is in contradistinction to a proper ballroom dancing positioning.

The vest 10 worn by each partner can be used to ensure proper body placement relative to the other partner. The first partner can unhook the hooks 72 at the second ends 64 of the first and second elastic bands 62 on his vest 10 from the two band cuffs 74 that remain connected to first and second quarter panels 16,18. The first partner will then connect the hooks 72 from his elastic bands 62 onto the upper connectors on the rear panel 14 of the vest 10 worn by the second partner. More particularly, the first partner uses his right hand to unhook the hook 72 on the first elastic band 62 from the band cuff 74 on the second quarter panel 18 on his vest 10. Then, this hook 72 is hooked or connected to the upper left connector 58 on the rear panel 18 of the second partner. The first partner uses his left hand to unhook the hook 72 on the first elastic band 62 from the band cuff 74 on the first quarter panel 16. Then, the hook 72 on the second elastic band 62 is hooked or connected to the upper right connector 60 on the rear panel 18 of the second vest 10. The two elastic bands 62 couple the first vest 10 to the second vest 10. Notably, this represents only one configuration option for connecting two dancers. There are other variations for connecting two vests to create different body connections.

The pair of vests that are worn by the partners encourage the partners to lean against the resistance imparted by elastic bands. This trains the partners to maintain a proper dancing position in which their upper bodies are spaced apart and their lower bodies are pressed together. In this proper position, the two partners may then practice their dance step routine while maintaining the proper body position throughout the step sequence or routine.

FIG. 6 depicts the operation of a single user of the vest 10 practicing the proper partner position depicted in FIG. 5 but without the need of a partner. In this instance, the dancer can hook the hooks 72 at the second ends of his two elastic bands 62 to a looped anchor 76 connected to a wall 78. The user can then lean back to simulate the proper partner dancing position in FIG. 5. The distinction is that when he is solo practicing, his upper body will lean away from the wall 78 while his lower body will press towards or against the wall 78. This position trains and reinforces the dancer to maintain the proper partner position without the need for being connected to a partner as depicted in FIG. 5.

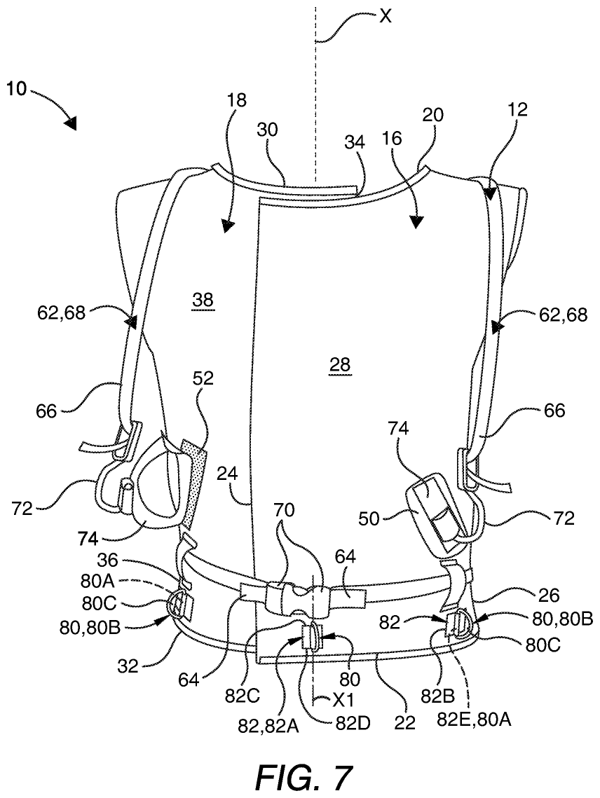

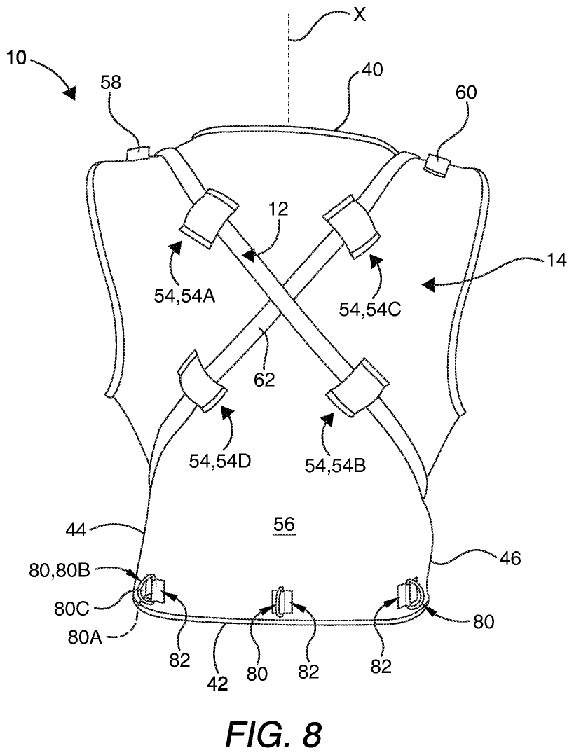

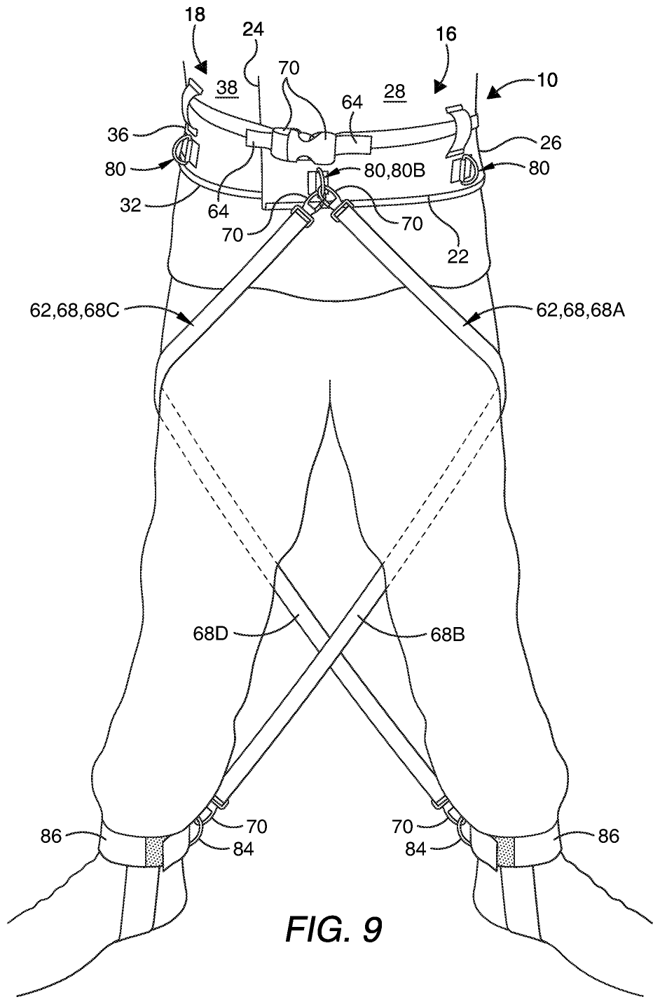

With primary reference to FIG. 7, FIG. 8, and FIG. 9, an alternative configuration of the dance training vest 10 can be used which allows the wearer or user of the vest 10 to become more aware of the movement of their legs. More particularly, for some dance movements, it is beneficial to keep the legs of the dancer within a desired, or acceptable, range of movement, and this third configuration simulates the force required for the dancer to keep their legs within the desired, or acceptable, range of movement. When using vest 10 in this third configuration, a legband, or supplemental cuff, is connected proximate an ankle region of the user and extends around the wearer or user's leg as more fully described below.

In this third configuration, the vest 10 includes a plurality of lower connectors 80 operably engaged with panels 14,16, and 18, via a plurality of connection members 82. The plurality of lower connectors 80 are configured to secure the plurality of force simulating or resistance members 12 or components in a desired location to assist with the simulation of force during a dance step or a dancing maneuver. More particularly, the plurality of lower connectors 80 are operably engaged with the outer surface 28 of the first quarter panel 16, the outer surface 38 of the second quarter panel 18, and the outer surface 56 of the rear panel 14 via the connection members 82 as more fully described below.

In one particular embodiment, each of the plurality of lower connectors 80 and each of the plurality of connection members 82 are substantially similar in construction and, as such, will be discussed collectively. For example, one of the plurality of lower connectors 80 is a D-ring, and one of the plurality of connection members 82 is a short segment of material that is secured to the outer surface of panels 14, 16, and 18, and configured to pivotally couple the D-ring to one of the panels 14, 16, and 18. As such, the D-ring will also be referred to as 80 and the strap will also be referred to as 82. The D-ring 80 includes a straight portion 80A, a curved portion 80B, and an aperture 80C defined between the straight portion 80A and the curved portion 80B. The strap 82 includes a front 82A, a rear 82B, a top 82C, and a bottom 82D. When the strap 82 is coupled to one of the panels 14, 16, and 18, a space 82E is formed between one of the panels 14, 16, and 18, and the rear 82B of the strap 82. The space 82E extends from the top 82C to the bottom 82D generally vertically with respect to the longitudinal axis X. The straight portion 80A of the D-ring 80 is received within the space 82E to secure the D-ring 80 to one of the panels 14, 16, and 18. As such, the straight portion 80A of the D-ring 80 is positioned generally vertically with respect to the longitudinal axis X. The D-ring is pivotal about a pivot axis X1 defined vertically along the space 82E. Although the plurality of lower connectors 80 have been described as D-rings 80, and the plurality of connection members 82 have been described as straps 82, it is to be entirely understood that the plurality of lower connectors 82 may be any suitable connectors and may be operably engaged with the panels 14, 16, and 18, in any suitable manner.

With continued reference to FIG. 7 through FIG. 9, and in one embodiment, the plurality of lower connectors 80 includes at least five lower connectors 80. In one embodiment there are five lower connectors 80 and in another embodiment there are six lower connectors 80. Two lower connectors 80 are operably engaged with the first quarter panel 16, one lower connector 80 is operably engaged with the second quarter panel 18, and three lower connectors 80 are operably engaged with the rear panel 14. The lower connectors 80 on the first quarter panel 16 are coupled to and extend outwardly from the outer surface 28 of the first quarter panel 16 via the connection members 82 and are positioned along the lower edge or hem 22 of the first quarter panel 16. The lower connector 80 on the second quarter panel 18 is coupled to and extends outwardly from the outer surface 38 of the second quarter panel 18 via the connection member 82 and is positioned adjacent the lower edge or hem 32 of the second quarter panel 18. The lower connectors 80 on the rear panel 14 are coupled to and extend outwardly from the outer surface 56 of the rear panel 14 via the connection members 82 and are positioned along the lower edge or hem 42 of the rear panel 14.

Reference will now be made to the plurality of force simulating or resistance members 12 or components and how they are connected to the vest 10 via the lower connectors 80. In this third configuration, the plurality of force simulating or resistance members or components connected to the lower connectors 80 are substantially similar in construction to the elastic resistance bands 62 discussed above with some minor changes/exceptions which will be discussed in greater detail herein. Similarly, the elastic band 62 includes the first end 64 and the second end 66 with the elongated elastic body 68 extending therebetween. The elastic body 68 may have any shape in cross section, such as circular or rectangular. However, it may be preferable to utilize a rectangular cross section such that a flat surface of the band lies flat against the outer surface of the rear panel 14 and the first and second quarter panels 16,18. Similarly, the first end 64 of the elastic band 62 includes the releasable connector 70, such as, for example, a metal loop having a mechanically openable and closable gate. Instead of the hook 72 defining the second end 66, the second end 66 includes a releasable connector 70 similar to the releasable connector 70 of the first end 64, a complementary connector 84, and a securing mechanism 86. In one example, the complementary connector 84 is a metal loop and the securing mechanism 86 is legband, or supplemental cuff, having a hook-and-loop closure mechanism, however, it is to be understood that the complementary connector 84 may be any suitable connector, and the securing mechanism 86 may be any suitable securing mechanism. The releasable connector 70 of the second end 66 is operably engaged with the complementary connector 84 and the complementary connector 84 is operably engaged with the securing mechanism 86. The releasable connector 70 of the first end 64 is configured to releasably connect with one of the lower connectors 80. The securing mechanism 86 is configured to releasably connect with the user's leg proximate the ankle region of the user.

Having thus described the structure of the elastic bands 62 in this third configuration, reference is now made to the connection of two elastic bands 62 to the vest 10, a right leg of the user, and a left leg of the user. As shown in FIG. 9, the first end 64 of one elastic band 62 is releasably connected to one of the plurality of lower connectors 80 operably engaged with the first quarter panel 16. More particularly, the releasable connector 70 of the first end 64 of the elastic band 62 is releasably connected to the D-ring of the lower connector 80. The securing mechanism 86 of the second end 66 is releasably connected with the right leg of the user proximate the ankle region of the right leg. When releasably connecting the securing mechanism 86 to the right leg, the securing mechanism 86 passes around a front of the left leg of the user before placing the securing mechanism 86 around the right leg of the user proximate the ankle region. The securing mechanism 86 is releasably secured to the right leg via the hook-and-loop mechanism.

More particularly, and as shown in FIG. 9, a first portion 68A of the elastic body 68 of this elastic band 62 is oriented in a first diagonal orientation relative to the longitudinal axis X. The axis along which the first portion 68A is oriented is at an angle in a range from about 30 degrees to about 60 degrees relative to the longitudinal axis X. The first portion 68A extends diagonally downwardly and passes around the left leg generally above a knee of the user. A second portion 68B of the elastic body 68 of this elastic band 62 is oriented in a second diagonal orientation relative to the longitudinal axis X. The axis along which the second portion 68B is oriented is at an angle in a range from about 30 degrees to about 60 degrees relative to the longitudinal axis X. The second portion 68B extends diagonally downwardly and passes behind the left leg of the user proximate the knee of the user. As shown in FIG. 9, the first diagonal direction is generally opposite to the second diagonal direction.

With continued reference to FIG. 9, the first end 64 of another elastic band 62 is releasably connected to the same lower connector 80 of the first quarter panel 16 that is operably engaged with the other elastic band 62. More particularly, the releasable connector 70 of the first end 64 of the elastic band 62 is releasably connected to the D-ring of the lower connector 80. The securing mechanism 86 of the second end 66 is releasably connected with the left leg of the user proximate the ankle region of the left leg. When releasably connecting the securing mechanism 86 to the left leg, the securing mechanism 86 passes around a front of the right leg of the user before placing the securing mechanism 86 around the left leg of the user proximate the ankle region. The securing mechanism 86 is releasably secured to the left leg via the hook-and-loop mechanism.

More particularly, and as shown in FIG. 9, a first portion 68C of the elastic body 68 of this elastic band 62 is oriented in a first diagonal orientation relative to the longitudinal axis X. The axis along which the first portion 68C is oriented is at an angle in a range from about 30 degrees to about 60 degrees relative to the longitudinal axis X. The first portion 68C extends diagonally downwardly and passes around the right leg generally above a knee of the user. A second portion 68D of the elastic body 68 of this elastic band 62 is oriented in a second diagonal orientation relative to the longitudinal axis X. The axis along which the second portion 68D is oriented is at an angle in a range from about 30 degrees to about 60 degrees relative to the longitudinal axis X. The second portion 68D extends diagonally downwardly and passes behind the right leg of the user proximate the knee of the user. As shown in FIG. 9, the first diagonal direction is generally opposite to the second diagonal direction.

With continued reference to FIG. 9, the second portion 68B of one elastic band 62 and the second portion 68D of the other elastic band 62 define an X-shaped configuration behind the legs of the user. Although a particular orientation of the elastic bands 62 has been described, it is to be entirely understood that the elastic bands 62 may be configured in any suitable configuration. For example, one or more the elastic bands 62 can be reliably connected to one or more of the plurality of lower connectors 80 in a similar manner.

Having described the structure of the vest 10 and its associated components in the third configuration, one exemplary use and operation of the vest 10 will be described herein.

Initially, the user shall don (i.e., put on) the vest 10 by opening the first and second quarter panels 16,18. Then, the user will have access to move their arms through the arm holes defined by panels. With the vest 10 draped from the shoulders, the user may close the vest by connecting the front edges of the first and second quarter panels 16,18. As discussed above, this may be accomplished in a conventional manner, such as through the use of a zipper, buttons, or a hook-and-loop connection.

FIG. 9 depicts that when training with vest 10 without a partner wearing a similar vest, the user releasably connects one elastic band 62 to one of the plurality of lower connectors 80 and to a leg of the user. The user releasably connects another elastic band 62 to the same lower connector 80 and to the other leg of the user. The user performs a dance movement and the elastic bands 62 simulate the need or reminder for the dancer to maintain their legs within a desired, or acceptable, range of movement. This is helpful inasmuch as dancers typically get lackadaisical or lazy during dance practice and let their legs move beyond the desired, or acceptable, range of movement. The resistance imparted by the elasticity of the body 68 of the elastic bands 62 simulates the force required for the dancer to maintain their legs within the desired, or acceptable, range of movement. As such, the vest 10 encourages the dancer to maintain his legs with the desired, or acceptable, range of movement. Notably, the desired, or acceptable, range of leg movement varies depending on the type of dance. For example, the desired, or acceptable, range of leg movement differs from ballroom dancing, a waltz, fox trot, or tango. As such, the user can choose a particular configuration of one or more of the elastic bands 62 to “remind” the user to stay within a desired, or acceptable, range of leg movement.

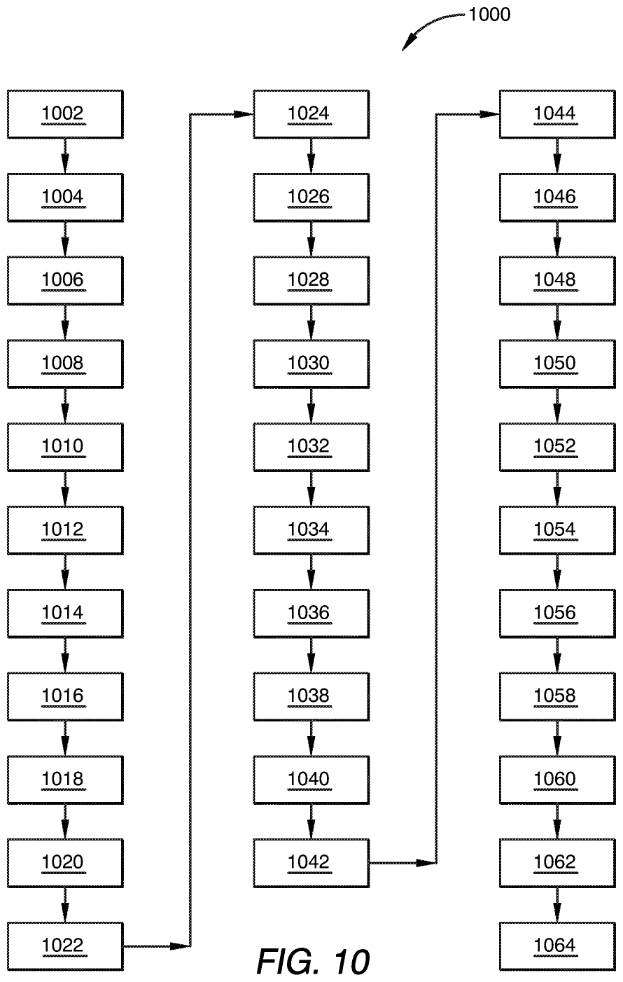

FIG. 10 depicts a method for dance training generally at 1000. The method 1000 includes donning, by a user, a first dance training vest, which is shown generally at 1002. The method 1000 includes connecting a first end of a first force simulating member to the first training vest, which is shown generally at 1004. The method 1000 includes moving in a dance movement to move the first dance training vest, which is shown generally at 1006. The method 1000 includes imparting a force of the first force simulating member to the first training vest, which is shown generally at 1008. The method 1000 includes operably engaging a second end of the first force simulating member to a first band cuff, which is shown generally at 1010. The method 1000 includes moving a first arm of the user toward the first band cuff and grasping, with a first hand of the user, the first band cuff, which is shown generally at 1012. The method 1000 includes placing the first arm, the first hand, and the first band cuff of the user in a first proper dance alignment, which is shown generally at 1014. The method 1000 includes moving in the dance movement to move the first dance training vest, which is shown generally at 1016. The method 1000 includes imparting the force of the first force simulating member to the dance training vest to maintain the first arm, the first hand, and the first band cuff in the first proper dance alignment while moving in the dance movement, which is shown generally at 1018. The method 1000 includes removing the first dance training vest, which is shown generally at 1020. The method 1000 includes repeating the dance movement without the first training vest, which is shown generally at 1022. The method 1000 includes maintaining the first proper dance alignment during the dance movement in a manner trained through the impartment of the force via the first force simulating member while the first training vest was worn, which is shown generally at 1024.

The method 1000 further includes connecting a first end of a second force simulating member to the first training vest, which is shown generally at 1026. The method 1000 includes operably engaging a second end of the second force simulating member to a second band cuff, which is shown generally at 1028. The method 1000 includes moving a second arm of the user toward the second band cuff, and grasping, with a second hand of the user, the second band cuff, which is shown generally at 1030. The method 1000 includes placing the second arm, the first hand, and the first band cuff of the user in a second proper dance alignment, which is shown generally at 1032. The method 1000 includes moving in the dance movement to move the first dance training vest, which is shown generally at 1034. The method 1000 includes imparting a force of the second force simulating member to the dance training vest to maintain the second arm, the second hand, and the second band cuff in the second proper dance alignment while moving in the dance movement, which is shown generally at 1036. The method 1000 includes removing the first dance training vest, repeating the dance movement without the first training vest, which is shown generally at 1038. The method 1000 includes maintaining the second proper dance alignment during the dance movement in a manner trained through the impartment of the force via the second force simulating member while the first training vest was worn, which is shown generally at 1040.

In another example, the method 1000 further includes connecting a second end of the first force simulating member to a second dance training vest adapted to be donned by a dance partner, which is shown generally at 1042. The method 1000 includes moving in the dance movement in a proper dance alignment to move the first dance training vest simultaneous to movement of the second dance training vest, which is shown generally at 1044. The method 1000 includes imparting the force of the first force simulating member simultaneously to both the first training vest and the second training vest, which is shown generally at 1046. The method 1000 includes removing the first dance training vest, which is shown generally at 1048. The method 1000 includes repeating the dance movement without the first training vest, which is shown generally at 1050. The method 1000 includes maintaining the proper dance alignment during the dance movement in a manner trained through the impartment of the force via the first force simulating member while the first training vest was worn, which is shown generally at 1052.

The method further includes connecting a first end of a second force simulating member to the first training vest, which is shown generally at 1054. The method 1000 includes operably engaging a second end of the second force simulating member to the second dance training vest, which is shown generally at 1056. The method 1000 includes moving in the dance movement in the proper dance alignment to move the first dance training vest simultaneous to movement of the second dance training vest, which is shown generally at 1058. The method 1000 includes imparting the force of the first force simulating member and the second force simulating member simultaneously to both the first training vest and the second training vest, which is shown generally at 1060. The method 1000 includes removing the first dance training vest, which is shown generally at 1062. The method 1000 includes repeating the dance movement without the first training vest, which is shown generally at 1064. The method 1000 includes maintaining the proper dance alignment during the dance movement in a manner trained through the impartment of the force via the first force simulating member and the second force simulating member while the first training vest was worn, which is shown generally at 1066.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A dance training vest comprising:
a first band cuff operably engaged with the vest;
a second band cuff operably engaged with the vest; and
a plurality of force simulating members operably engaged with the vest, the first band cuff, and the second band cuff; wherein the plurality of force simulating members is positioned in a desired location to assist with the simulation of proper user position during a dance movement.

2. The dance training vest of claim 1, further comprising:
a first releasable connector provided on the vest releasably connected to the first band cuff; and
a second releasable connector provided on the vest releasably connected to the second band cuff.

3. The dance training vest of claim 2, further comprising:
a front of the vest; wherein the first releasable connector and the second releasable connector are provided on the front of the vest.

4. The dance training vest of claim 3, further comprising:
first and second forward quarter panels of the vest; and
a rear panel of the vest connected to the first forward quarter panel at a first side and the second forward quarter panel at a second side; wherein the first releasable connector is provided on the first forward quarter panel; and wherein the second releasable connector is provided on the second forward quarter panel.

5. The dance training vest of claim 4, further comprising:
a plurality of connectors provided on the vest; wherein the plurality of connectors is operably engaged with the plurality of force simulating members.

6. The dance training vest of claim 5, wherein the plurality of connectors is positioned on the rear panel of the vest.

7. The dance training vest of claim 6, further comprising:
four connectors of the plurality of connectors; wherein two connectors of the four connectors are positioned along a first axis; wherein the other two connectors of the four connectors are positioned along a second axis; and wherein the first axis intersects the second axis.

8. The dance training vest of claim 7, further comprising:
a first elastic band of the plurality of force simulating members; wherein the first elastic band includes a first end, a second end, and an elongated elastic body extending therebetween; and
a second elastic band of the plurality of force simulating member; wherein the second elastic band includes a first end, a second end, and an elongated elastic body extending therebetween.

9. The dance training vest of claim 7, further comprising:
a connection between respective first ends of the first and second elastic bands forwardly from the first and second quarter panels and below the first and second releasable connectors; wherein the first elastic band extends generally along the first axis through apertures defined by two of the four connectors; wherein the first elastic band is releasably connected to the first band cuff; wherein the second elastic band extends generally along the second axis through apertures defined by the other two of the four connectors; and wherein the second elastic band is releasably connected to the second band cuff.

10. The dance training vest of claim 8, further comprising:
a left upper connector provided on the rear panel of the vest; and
a right upper connector provided on the rear panel of the vest; wherein the left upper connector and the right upper connector are configured to releasably receive the first elastic band and the second elastic band.

11. The dance training vest of claim 1, further comprising:
a plurality of lower connectors provided adjacent a bottom of the vest;
a first elastic band of the plurality of force simulating members; wherein the first elastic band includes a first end, a second end, and an elongated elastic body extending therebetween;
a second elastic band of the plurality of force simulating members; wherein the second elastic band includes a first end, a second end, and an elongated elastic body extending therebetween; and
a releasable connection between respective first ends of the first and second elastic bands with the plurality of lower connectors; wherein the first elastic band is releasably connected to the first band cuff; and wherein the second elastic band is releasably connected to the second band cuff.

12. A method for dance training comprising:
donning, by a user, a first dance training vest;
connecting a first end of a first force simulating member to the first training vest;
moving in a dance movement to move the first dance training vest; and
imparting a force of the first force simulating member to the first training vest.

13. The method of claim 12, further comprising:
operably engaging a second end of the first force simulating member to a first band cuff;
moving a first arm of the user toward the first band cuff;
grasping, with a first hand of the user, the first band cuff;
placing the first arm, the first hand, and the first band cuff of the user in a first proper dance alignment;
moving in the dance movement to move the first dance training vest; and
imparting the force of the first force simulating member to the first dance training vest to maintain the first arm, the first hand, and the first band cuff in the first proper dance alignment while moving in the dance movement.

14. The method of claim 13, further comprising:
removing the first dance training vest;
repeating the dance movement without the first training vest; and
maintaining the first proper dance alignment during the dance movement in a manner trained through the impartment of the force via the first force simulating member while the first training vest was worn.

15. The method of claim 13, further comprising:
connecting a first end of a second force simulating member to the first training vest;
operably engaging a second end of the second force simulating member to a second band cuff;
moving a second arm of the user toward the second band cuff;
grasping, with a second hand of the user, the second band cuff;
placing the second arm, the first hand, and the first band cuff of the user in a second proper dance alignment;
moving in the dance movement to move the first dance training vest; and
imparting a force of the second force simulating member to the first dance training vest to maintain the second arm, the second hand, and the second band cuff in the second proper dance alignment while moving in the dance movement.

16. The method of claim 15, further comprising:
removing the first dance training vest;
repeating the dance movement without the first training vest; and
maintaining the second proper dance alignment during the dance movement in a manner trained through the impartment of the force via the second force simulating member while the first training vest was worn.

17. The method of claim 12, further comprising:
connecting a second end of the first force simulating member to a second dance training vest adapted to be donned by a dance partner;
moving in the dance movement in a proper dance alignment to move the first dance training vest simultaneous to movement of the second dance training vest; and
imparting the force of the first force simulating member simultaneously to both the first training vest and the second training vest.

18. The method of claim 17, further comprising:
removing the first dance training vest;
repeating the dance movement without the first training vest; and
maintaining the proper dance alignment during the dance movement in a manner trained through the impartment of the force via the first force simulating member while the first training vest was worn.

19. The method of claim 17, further comprising:
connecting a first end of a second force simulating member to the first training vest;
operably engaging a second end of the second force simulating member to the second dance training vest;
moving in the dance movement in the proper dance alignment to move the first dance training vest simultaneous to movement of the second dance training vest; and
imparting the force of the first force simulating member and the second force simulating member simultaneously to both the first training vest and the second training vest.

20. The method of claim 19, further comprising:
removing the first dance training vest;
repeating the dance movement without the first training vest; and
maintaining the proper dance alignment during the dance movement in a manner trained through the impartment of the force via the first force simulating member and the second force simulating member while the first training vest was worn.
